(19) United States
(12) Patent Application Publication
(10) Pub. No.: US 2010/0143810 A1
(43) Pub. Date: Jun. 10, 2010

(54) Fuel Cell System and Method of Operating the Same

(75) Inventors: Hans-Joerg Heidrich, Ulm (DE); Uwe Limbeck, Kirchheim (DE); Holger Richter, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignees: DAIMLER AG, STUTTGART (DE); FORD GLOBAL TECHNOLOGIES, LLC, DEARBORN, MI (US)

(21) Appl. No.: 12/513,334

(22) PCT Filed: Sep. 7, 2007
(86) PCT No.: PCT/EP07/07810

§ 371 Date: Jan. 21, 2010

(30) Foreign Application Priority Data
Nov. 2, 2006 (DE) 10 2006 051 674.5

(51) Int. Cl. H01M 8/06; H01M 8/04

(52) U.S. Cl. 429/421; 429/416; 429/422; 429/423

(57) ABSTRACT

A method of operating a fuel cell system with at least one fuel cell unit comprising a plurality of fuel cells, each having one anode and one cathode, the anode adjoining an anode gas compartment and the cathode adjoining a cathode gas compartment, hydrogen being supplied to the anode and an oxidizing agent being supplied to the cathode. Hydrogen is supplied to the anode compartment during a retention time before start-up of the fuel cell system, in which no fuel cell reaction takes place in the fuel cell unit. Hydrogen is stored in an adsorption storage element during fuel cell operation and released to the anode compartment during the retention time.

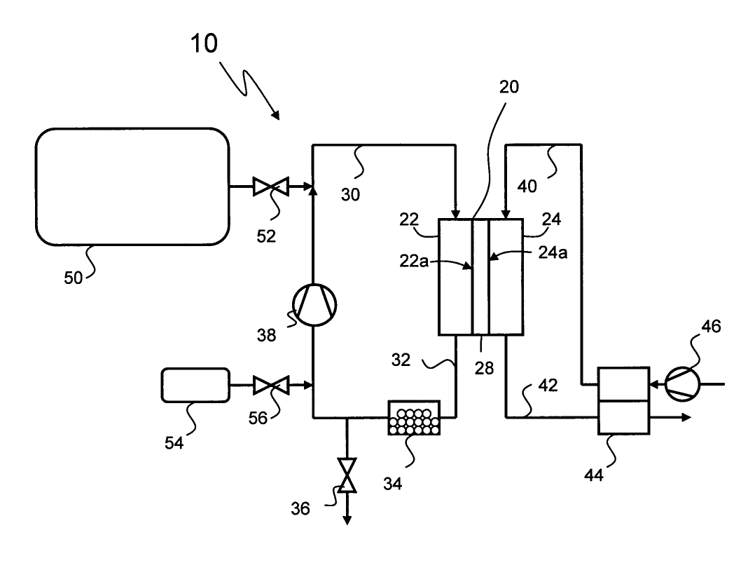

This application is a national stage of International Application No. PCT/EP2007/007810, filed Sep. 7, 2007, which claims priority under 35 U.S.C. §119 to German Patent Application No. 10 2006 051 674.5, filed Nov. 2, 2006, the entire disclosure of which is herein expressly incorporated by reference.

### BACKGROUND AND SUMMARY OF THE INVENTION

The present invention relates to a fuel cell system and to a method of operating the same.

Cathode corrosion is known to occur in fuel cell systems, particularly those with polymer electrolyte membranes. Such cathode corrosion arises, for example when the cathode side of the fuel cell is filled with oxygen (e.g., air), while at the same time the anode side displays non-uniform concentration conditions of different media (such as for instance areas which are filled with inert gas and oxygen and other areas which are filled with inert gas and hydrogen). Non-homogeneous distribution of the oxygen and hydrogen on the anode side leads to undesired electrical potentials within the fuel cell, such that a carbon support of the cathode catalyst oxidizes (i.e., corrodes), and leaves the fuel cell in the form of CO2.

It is known that the presence of hydrogen in the fuel cell reduces corrosion. To this end, the anode may remain filled, for example with hydrogen, after being switched off. Problematically, however, hydrogen diffuses from the fuel cell or the fuel cell stack over time, such that significant corrosion may be noted on starting.

Numerous proposals have been made for dealing with this problem. German patent document DE 199 53 614 A1, for example, proposes making the anode gas compartment of a fuel cell unit at least twice as large as a cathode gas compartment, so as to assure that sufficient hydrogen is present in the anode compartment to protect the fuel cell unit from corrosion, even after the fuel cell unit has been switched off.

Japanese patent document JP-A-2004-179054 furthermore proposes to introduce hydrogen from a feed tank into the fuel cell unit on the anode side, upon switching off of the fuel cell unit.

Published U.S. Patent Application Nos. 2005/031917 A1 and 2002/076582 A1, as well as European patent document EP 635 414 A1, each disclose a method of operating a fuel cell system with at least one fuel cell unit comprising a plurality of fuel cells (each having an anode and a cathode). The anode adjoins an anode gas compartment and the cathode adjoins a cathode gas compartment, with hydrogen being supplied to the anode and an oxidizing agent being supplied to the cathode. Hydrogen is supplied to the anode compartment shortly before the start of the fuel cell system during a retention time in which no fuel cell reaction takes place in the fuel cell unit.

One object of the present invention is to provide a fuel cell system and a method of operating the same in which corrosion of the cathode is reduced.

This and other objects and advantages are achieved by the method according to the invention for operating a fuel cell system with at least one fuel cell unit comprising a plurality of fuel cells, (each having one anode and one cathode). The anode adjoins an anode gas compartment, and the cathode adjoins a cathode gas compartment, with hydrogen being supplied to the anode and an oxidizing agent being supplied to the cathode. Hydrogen is supplied to the anode compartment shortly before start-up of the fuel cell system during a retention time in which no fuel cell reaction takes place in the fuel cell unit.

According to the invention, hydrogen is stored in an adsorption storage device during fuel cell operation and released during the retention time. This may preferably proceed passively, by using hydrogen which escapes when the fuel cell system is at a standstill, due to the relatively low hydrogen partial pressure and the relatively low system temperature. Optionally, the escaping volume may be intentionally increased for instance by increasing the temperature of the adsorption storage component.

Advantageously, in this way the corrosion processes may be reduced during a period that is particularly critical for possible corrosion, by making hydrogen available while the fuel cell unit is inactive, so that the service life of the fuel cell unit may be increased significantly. Because the anode compartment does not have to be kept under a hydrogen atmosphere for the entire time during which the fuel cell unit or the fuel cell system idle, undesired hydrogen emission is reduced. Preferably, the anode compartment is exposed to hydrogen for the purpose of corrosion prevention while the fuel cell is inactive only over a period shortly before start-up of the fuel cell system. During this period, the hydrogen may be supplied constantly or at (preferably regular) intervals. Preferably, hydrogen is supplied which has been passively released, or which is available anyway.

The hydrogen may also be supplied from a compressed gas tank, which also serves as the feed tank. In this case, it is favorable for the fuel to be distributed as uniformly as possible within the anode compartment, and a recirculation blower may be provided for this purpose, in a hydrogen return line.

Furthermore, the hydrogen may be supplied from a liquid hydrogen tank, which serves as the feed tank. In this case, it is particularly advantageous that hydrogen which vaporizes passively out of the liquid hydrogen tank (and would otherwise conventionally present a problem) may be used and supplied to the anode compartment. In addition, or alternatively, the hydrogen may also be supplied from an additional storage tank.

The invention also includes a fuel cell system for performing the method according to any one of the preceding claims. The system comprises at least one fuel cell unit made up of a plurality of fuel cells, each having an anode and a cathode, with the anode adjoining an anode gas compartment and the cathode adjoining a cathode gas compartment. Hydrogen is suppliable to the anode, while an oxidizing agent is suppliable to the cathode. Moreover, means are provided for supplying hydrogen to the anode compartment shortly before start-up of the fuel cell system during a retention time in which no fuel cell reaction takes place in the fuel cell unit. If the anode compartment is filled with hydrogen, a possible anode return attached thereto is also filled with hydrogen.

According to the invention, an adsorption storage element is provided in a hydrogen return line, and is loaded during fuel cell operation. Hydrogen may then be released passively (or also actively by heating of the adsorption storage means, for example.) It is favorable to use reversibly hydride-forming metals, for example, palladium and the alloys thereof, such as PdCu, PdAg; nickel and the alloys thereof, such as LaNiₓ; iron and the alloys thereof, such as FeTiₓ; magnesium and the alloys thereof, such as MgNiₓ; other hydrides, such as aluminum hydride (NaAlHₓ), borohydride (NaBHₓ); or oxides, such as FeOₓ. Other media which adsorb hydrogen are also suitable, such as for instance graphite materials consisting of so-called single-wall or multi-wall carbon nanotubes made of Buckminster Fullerenes, or organic hydrogen reservoirs, such as polymers with intrinsic microporosity (“PIM polymers”), or inorganic porous materials, such as zeolites. So-called microspheres, such as for instance glass balls which are filled with up to 10 000 bar hydrogen and release hydrogen slowly, are also suitable. All the materials may also be heated at least from time to time, to increase the hydrogen release rate.

The hydrogen may be supplied from a feed tank, (which may be a compressed gas tank or a liquid hydrogen tank). This embodiment is particularly space-saving. Furthermore, at least one additional storage tank may be provided, in the form of a compressed gas tank and/or a liquid hydrogen tank and/or an adsorption storage means and/or electrolyzer and/or a reforming unit for generating a hydrogen-rich reformate.

More favorably, the hydrogen may be fed into a hydrogen return line.

To distribute the hydrogen uniformly in the anode compartment and the adjoining hydrogen-conveying lines, a recirculation blower may be provided.

Other objects, advantages and novel features of the present invention will become apparent from the following detailed description of the invention when considered in conjunction with the accompanying drawings.

### BRIEF DESCRIPTION OF THE DRAWINGS

The single FIGURE shows a preferred fuel cell system with a plurality of hydrogen sources, which supply hydrogen for the inactive fuel cell unit in a so-called “soak phase”.

### DETAILED DESCRIPTION OF THE DRAWINGS

As is shown in the FIGURE, a preferred (schematically illustrated) fuel cell system 10 for performing the method according to the invention comprises a fuel cell unit 20 that includes a plurality of fuel cells, each having one anode 22a and one cathode 24a, with the anode 22a adjoining an anode gas compartment 22 and the cathode 24a adjoining a cathode gas compartment 24. For simplicity, the fuel cell unit 20 is shown as an individual fuel cell with anode compartment 22 and anode 22a, cathode compartment 24 and cathode 24a, and membrane 28. A plurality of hydrogen sources for preventing corrosion are provided in combination, such as are illustrated by reference numerals 50, 54 and 34. Further conventional components of the fuel cell system 10 are not shown explicitly, but may be provided, as a person skilled in the art will be aware.

The cathode compartment 24 is exposed to an oxidizing agent (conventionally air), which is compressed by means of a compressor 46 and passes via a heat exchanger 44 in a feed line 40 into the cathode compartment 24. In the heat exchanger 44, the oxidizing agent exchanges heat with fuel cell exhaust gas from the cathode side, which gas arrives at the heat exchanger 44 in the line 42.

On the anode side a feed line 30 is provided, in which fresh hydrogen is fed from a feed tank 50 (for example a compressed gas tank or a liquid hydrogen tank) to the anode compartment 22. The feed tank 50 may be uncoupled from the anode compartment by a valve 52.

Fuel cell exhaust gas from the anode side is passed via a return line 32 to the anode-side input of the fuel cell unit 20. To this end, a recirculation blower 38 is provided in the return line. An additional feed tank 54 is connected to the return line 32 upstream of the recirculation blower 38. The additional feed tank 54 may be uncoupled from the return line 32 by a valve 56. The additional storage tank 54 may be a compressed gas tank, a liquid hydrogen tank, an adsorption storage device, and electrolyzer, or a reforming unit for producing a hydrogen-rich reformate.

An adsorption storage element 34 is provided in the hydrogen return line 32 upstream of the junction with the additional storage tank 54, and upstream of the recirculation blower 38. In this way, the adsorption storage element 34 is straightforwardly loaded during active fuel cell operation. Downstream of the adsorption storage element 34 there is provided a valve 36, with which the return line 32 may be flushed to remove impurities from the return line 32 and the anode compartment 22.

Hydrogen, from adsorption storage means 34 and optionally at least one of the hydrogen sources 50, 54, is fed to the anode compartment 22 shortly before start-up of the fuel cell system 10 during a retention time, in which no fuel cell reaction takes place in the fuel cell unit 20. In order to distribute this hydrogen as uniformly as possible within the anode compartment 22, the recirculation blower 38 may optionally be used.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-7. (canceled)

8. A method of operating a fuel cell system with at least one fuel cell unit comprising a plurality of fuel cells, each of which has an anode and a cathode, the anode adjoining an anode gas compartment and the cathode adjoining a cathode gas compartment, hydrogen being supplied to the anode and an oxidizing agent being supplied to the cathode, said method comprising:
storing hydrogen in an adsorption storage element situated in a hydrogen flow line of said fuel cell during fuel cell operation; and
releasing the stored hydrogen to the anode compartment before start-up of the fuel cell system during a retention period in which no fuel cell reaction takes place in the fuel cell unit.

9. The method according to claim 8, wherein the hydrogen is supplied from an additional storage tank.

10. The method according to claim 8, wherein said step of releasing the stored hydrogen is performed passively, or actively by heating the adsorption element.

11. The method according to claim 8, wherein said adsorption storage element is made of a material selected from the group consisting of palladium, palladium alloys, nickel, nickel alloys, iron, iron alloys, magnesium, magnesium alloys, aluminum hydride, borohydride, and oxides.

12. A fuel cell system for performing the method according to claim 8, said fuel cell comprising:
at least one fuel cell unit having a plurality of fuel cells, each of which has an anode and a cathode, the anode adjoining an anode gas compartment and the cathode adjoining a cathode gas compartment;
apparatus for supplying hydrogen to the anode;
apparatus for supplying oxidizing agent to the cathode; and
means for supplying hydrogen to the anode compartment during a retention time before start-up of the fuel cell system, in which no fuel cell reaction takes place in the fuel cell unit;
wherein said means comprises an adsorption storage means provided in a hydrogen return line.

13. The fuel cell system according to claim 12, further comprising an additional hydrogen storage tank.

14. The fuel cell system according to claim 13, wherein the additional storage tank is one of a compressed gas tank, a liquid hydrogen tank an adsorption storage means, an electrolyzer, and a reforming unit for producing a hydrogen-rich reformate.

15. The fuel cell system according to claim 12, wherein the hydrogen is fed into a hydrogen return line.
